(19) United States
(12) Patent Application Publication
(10) Pub. No.: US 2005/0072134 A1
(43) Pub. Date: Apr. 7, 2005

(54) Rake system for crops

(75) Inventor: Ivan J. Cook, Hermiston, OR (US)

Correspondence Address: WELLS ST. JOHN P.S., 601 W. FIRST AVENUE, SUITE 1300, SPOKANE, WA, 99201, US

(73) Assignee: Ivan J. Cook

(21) Appl. No.: 10/680,085

(22) Filed: Oct. 5, 2003

(51) Int. Cl. A01D 76/00

(52) U.S. Cl. 56/377

(57) ABSTRACT

A crop rake system for controlling the location of tines on the rake, which may include a rotatable rotation framework with an axis of rotation; a plurality of tines mounted to the rotation framework radially outward from the axis of rotation of the rotation framework; and a plurality of tine dampeners mounted to the rotation framework radially outward from the axis of rotation of the rotation framework, the plurality tine dampeners being mounted relative to the plurality of tines such as to determine the depth at which the plurality of tines may penetrate into a ground surface. The invention also includes either separately or in combination, a means for contracting and transporting the rake system on roads and highways.

### CROSS REFERENCE TO RELATED APPLICATION

There are no related applications.

### TECHNICAL FIELD

This invention relates to a rake system for use in the raking of crops such as hay and the movement of a hay rake apparatus for raking activities and transport, including without limitation for ground driven wheel rakes.

### BACKGROUND OF THE INVENTION

A ground driven hay rake wheel is a rotatably mounted wheel structure with tines directed radially outward. The central axis of the traditional wheel rake is at an angle to the vehicle's forward travel such that as the wheel is pulled forward the tines of the rake come in contact with the ground causing the wheel to rotate. When the wheel rotates, the bottom portion of the wheel moves toward the center of the path of the vehicle, thereby raking the crop toward the intended position(s) of the windrow(s) being formed.

While the term hay may be used herein in reference to the crop being raked, this invention is not limited to hay but instead may include any other crop being raked, including without limitation hay, alfalfa and others.

As the tines below the axis of the rake wheel move toward the center line of the vehicle's path (or toward whatever location the windrow is desired), the cut crop such as hay coming in contact with the tines is also moved in the desired direction, thereby forming a windrow.

In current devices, as the rake wheel contacts the ground, the tines often penetrate the soil and potentially cause soil and/or rocks to be moved into the windrow. This negatively affects the crop in the windrow and causes excess wear of the tines.

Current crop rake configurations can also be difficult to transport between fields due to the framework configuration and the ability of the frameworks to contract for movement on public roads and highways.

It is therefore an objective of this invention to provide an improved crop rake system, including such an improved system for raking the crop and separately or in combination for transporting the rake system on roads and highways.

### BRIEF DESCRIPTION OF THE DRAWINGS

Preferred embodiments of the invention are described below with reference to the following accompanying drawings.

FIG. 1 is an elevation view of a crop rake system with the ground driven rake wheels raking the crop toward the center of the path of the pull vehicle;

FIG. 2 is a front perspective view of an embodiment of a rake wheel type of rake which may be utilized by this invention;

FIG. 3 is a rear elevation view of the rake wheel illustrated in FIG. 2;

FIG. 4 is a side section view of a tine and a loop from the rake wheel illustrated in FIG. 2;

FIG. 5 is a front elevation view of an example of another embodiment of a rake wheel which may be utilized by this invention, showing an alternative tine dampener;

FIG. 6 is a top view of an embodiment of the crop rake system wherein the rake framework is in a rake or extended position or mode;

FIG. 7 is a top view of an embodiment of the crop rake system wherein the rake framework is in a transport or contracted position or mode;

FIG. 8 is a detail front elevation view of an embodiment of a rake tine which may be utilized as part of this invention, such as on the rake wheel illustrated in FIG. 2;

FIG. 9 is a top view of an embodiment of the crop rake system wherein the rake framework is in a rake or extended position, or mode, and further wherein the wheels are utilized to extend and contract the rake framework;

FIG. 10 is top view of an embodiment of the invention illustrating a possible hydraulic configuration for the movement of the wheels and the rake mount arms to accomplish the extension and contraction; and

FIG. 11 is a side elevation view of the embodiment of the invention illustrated in FIG. 10.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown and described herein for any specific application of this invention can be varied or altered as anticipated by this invention, and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

The term pull vehicle as used herein may refer to any integrated or separate vehicle utilized to pull or push the rake system through the crop field, including tractors, trucks, windrow vehicles, and others, all within the contemplation of the invention. A desired aspect of one embodiment of this invention is the ability to couple this invention to a truck either through a receiver hitch or a fifth-wheel type of configuration and pull it through a field or transport it on roadways.

The term pull vehicle coupling when used relative to the rake system framework includes any structure or coupling configured to be operatively attached to a pull vehicle of any kind, including trucks and tractors, and may include what are known as fifth-wheel trailer type of connections, traditional hitch ball configurations, and others, all within the contemplation of this invention.

The term central base framework as used for purposes of this invention, includes framework structures: at the centerline of the rake system framework; within the vehicle path; and near the vehicle path; all within the contemplation of this invention, although the preferred central base framework may include a framework structure at or near the approximate centerline as shown in the preferred embodiment.

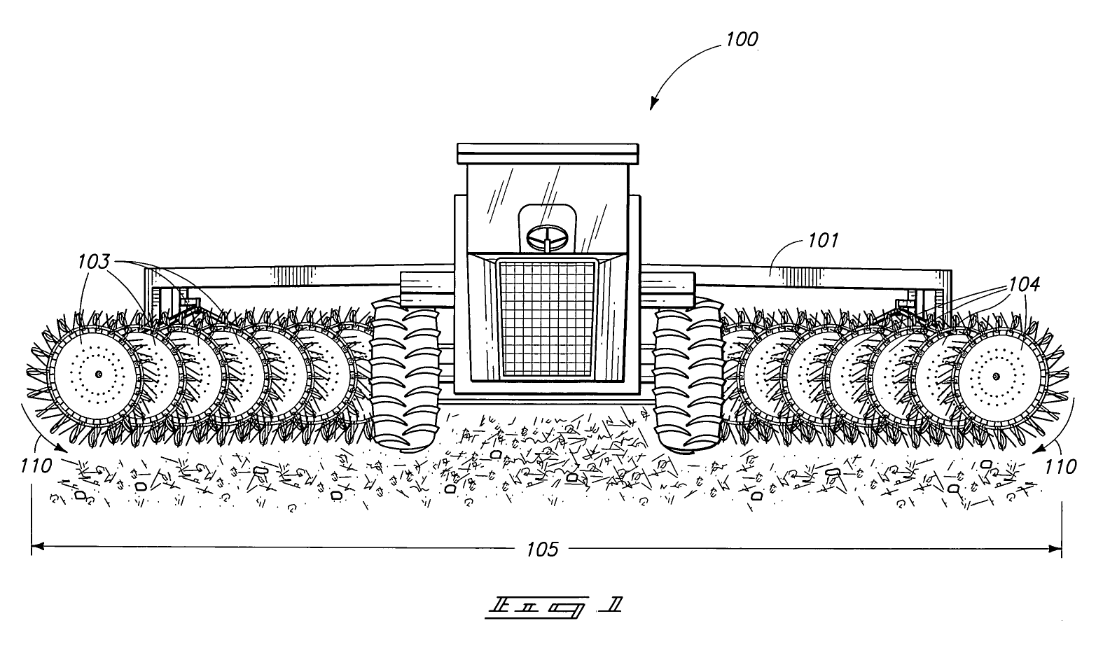

FIG. 1 is an elevation view of a crop rake system with the ground driven rake wheels raking the crop toward the center of the path of the pull vehicle, illustrating pull vehicle 100 (a tractor in this example), a first plurality of crop rakes 103 (wheel rakes in the embodiment shown), a second plurality of crop rakes 104, a raking width 105, with the respective pluralities of rakes 103 and 104 rotating in the directions of arrows 110, causing the crop to be raked toward the centerline of the raking system and pull vehicle.

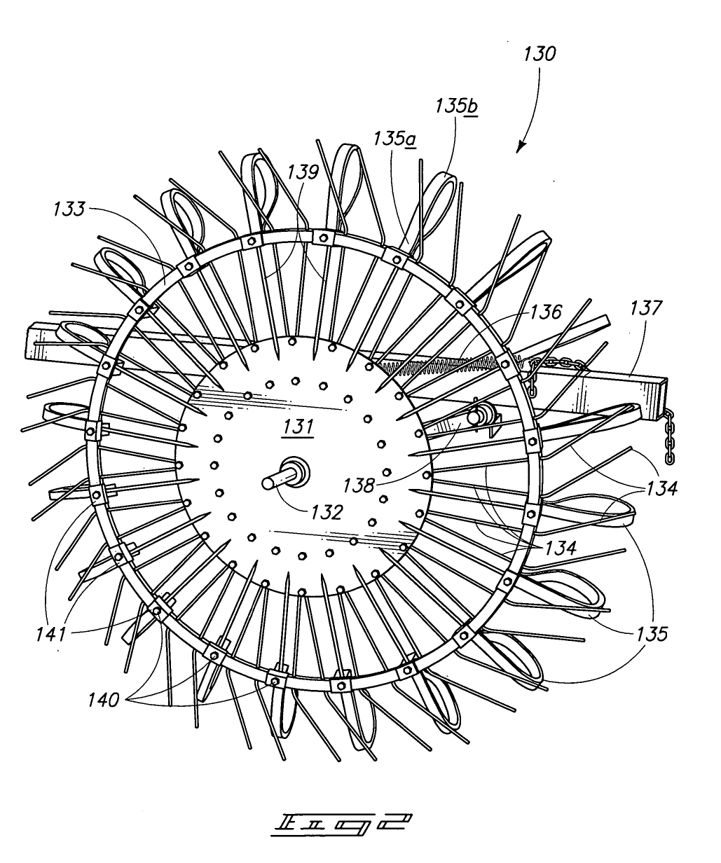

FIG. 2 is a front perspective view of an embodiment of a rake 130 which may be utilized by this invention, illustrating axis 132, inner rotation framework 131, outer rotation framework 133, a plurality of tines 134 mounted to inner rotation framework 131 and outer rotation framework 133 (which may collectively be referred to as rotation framework), and tine dampeners 135. The term tine dampener as used herein is used in a broad sense, and may mean buffers, supports, depth controllers, dampeners, and/or ground contact points for supporting that portion of the weight of the rake or rake wheel that is not suspended by a spring or other mechanism, so that the tines do not penetrate into the ground more than a desired amount, or at least to reduce the amount.

Tine dampeners 135 have radially inward ends 135a and radially outward ends 135b, and in this embodiment are shown mounted to the outer rotation framework 133 by mounting brackets 141. The mounting brackets 141 mount the tine dampeners 135 to the rotation framework and fasteners 140 may be used to located the mounting brackets 141 on the rotation framework and to retain or fasten the tine dampeners 135 to the mounting brackets 141.

The outer rotation framework 133 may be connected or secured to the inner rotation framework 131 by any one of a number of structures, including framework connectors 139. Further, an outer rotation framework 133 although preferred, is not required to practice the invention, but instead an inner rotation framework 131 with longer tine dampeners 135 may be utilized.

While any one of a number of flexible, resilient, semi-flexible or solid tine dampeners 135 may be utilized within the contemplation of this invention, the dampeners shown in FIG. 2 are flexible, semi-flexible or resilient loops as shown.

It will also be appreciated by those of ordinary skill in the art that the tine dampeners 135 may be made of any one of a number of different materials with no one in particular being required to practice this invention. In the embodiment shown in FIG. 2, an abrasion resistant material such as ultra-high molecular weight (UHMW) polyethylene plastic may be utilized.

The rake 130 is shown mounted to a rake mount structure 137 via rake mount arm 138 and rake mount spring 136. The rake mount spring 136 bias suspends the rake 130 (a wheel rake in the embodiment shown) from the rake mount structure 137 to allow it to move relative to the ground.

The forces imposed on the tine dampeners 135 will cause the suspended wheel rake to move upwardly and downwardly according to the contour of the ground or other surfaces over which the rakes will travel. The resiliency of the tine dampeners 135 must be balanced with the weight of the rake and the resiliency of the spring 136 utilized to suspend the rake, to achieve the approximate desired depth. The interaction of the tine dampeners 135 with the ground combined with the movement of the rake system relative to the ground will cause the rakes to rotate or be ground driven. In other embodiments of the invention the protrusion or the offset of the tines relative to the tine dampeners 135 may be adjusted such that the tines alone, the tine dampener(s) alone, or some combination thereof, may be the source of the ground driven force causing the rake to rotate.

The crop rake 130 shown in FIG. 2 will rotate about axis 132 causing the tines below the axis 132 to move toward the desired location for the windrow to be formed, thus moving the crop toward the desired location for the windrow to be formed.

It is known by those of ordinary skill in the art that these types of rotating crop rakes are ground driven, meaning the movement of the rake system relative to the ground causes the rotation of the rakes and consequently the tines on the rakes. In an embodiment of this invention the tine dampeners may be the part of the rake primarily or entirely in contact with and driven by the ground. The bias or spring suspension of the rakes (rake wheels in this embodiment) allows the rakes to move upward and downward relative to the surfaces encountered, such as the ground or objects on the ground. It is also an aspect of this invention to utilize other types of tine dampeners, such as an inner tube or tire type of attachment which may be operatively attached to the rake or wheel rake, thereby providing the depth control and the driving force for the rotation of the rake or the wheel rake, no matter if the pull vehicle is moving forward or backwards.

The use of the dampeners (items 135 in FIG. 2 for example) tends to reduce the amount of dirt, rocks and other debris that are undesirably placed into the windrow with the crop due to the tines penetrating deeper than desired into the ground or surface being raked.

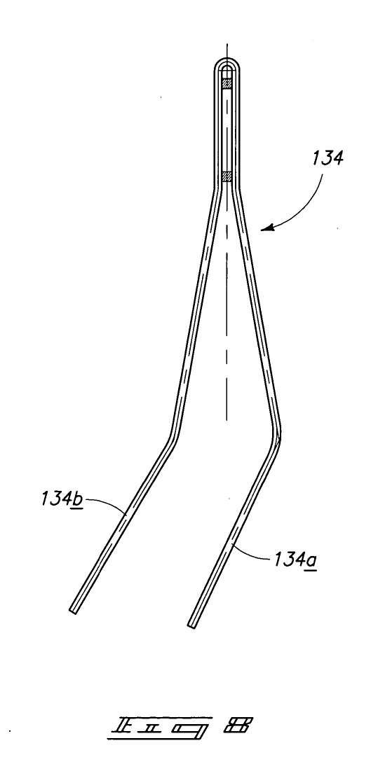

While there are numerous types, kinds and configurations of tines which may be used within the contemplation of this invention (and which may be well known by those of ordinary skill in the art), the tine illustrated in FIG. 8 is one example of a tine which is suited for applications such as this (as described more fully below).

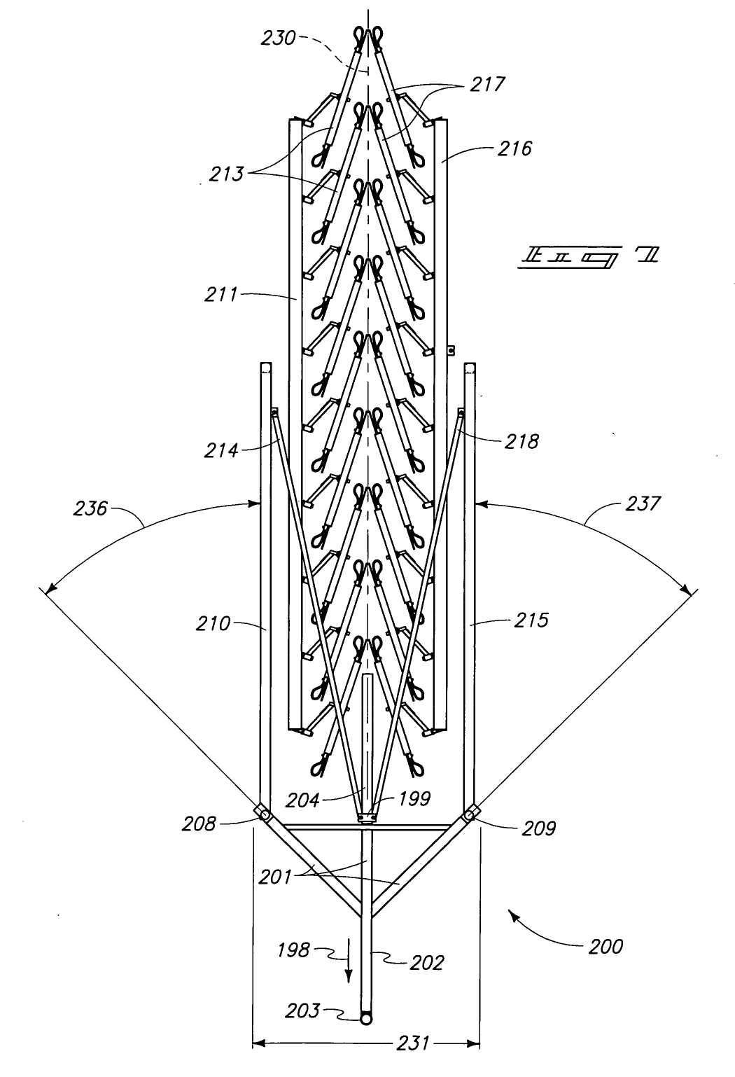

The rakes shown in FIG. 2 may be mounted at a ten to twenty degree angle relative to the rake mount structure 137, although no particular angle is required to practice this invention. FIG. 7 further illustrates a top view of the rake mount angles.

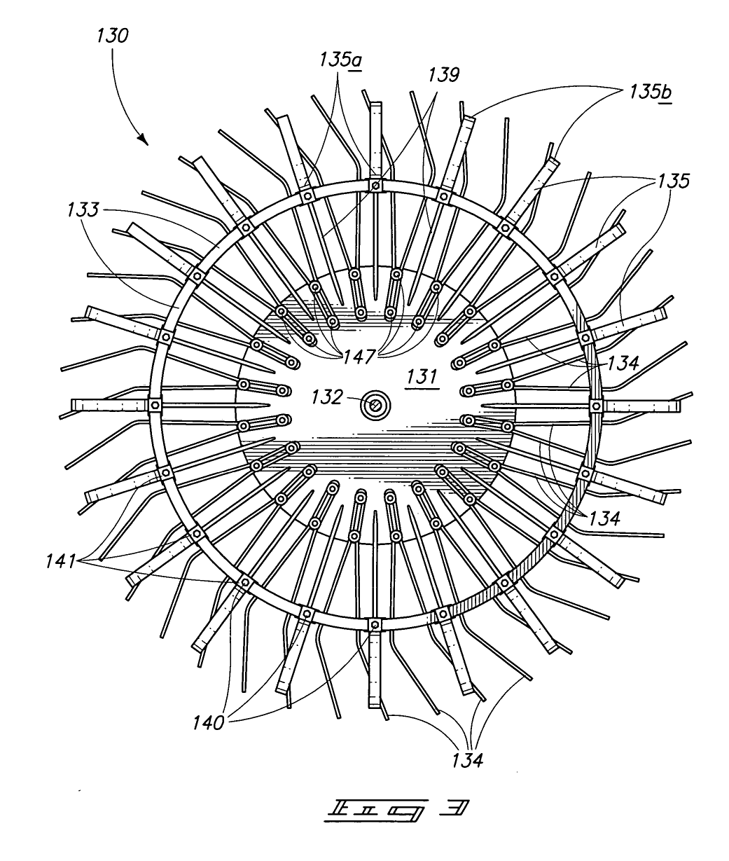

FIG. 3 is a rear elevation view of the rake wheel illustrated in FIG. 2. FIG. 3 illustrates axis 132, inner rotation framework 131, outer rotation framework 133, a plurality of tines 134 mounted to inner rotation framework 131 and outer rotation framework 133 (which may collectively be referred to as the rotation framework), and tine dampeners 135.

Tine dampeners 135 have radially inward ends 135a and radially outward ends 135b, and in this embodiment are shown mounted to the outer rotation framework 133 by mounting brackets 141. The outer rotation framework 133 may be UHMW (ultra high molecular weight) tubing to better interact with and wear relative to the metallic tines.

The mounting brackets 141 mount the tine dampeners 135 to the rotation framework and fasteners 140 may be used to located the mounting brackets 141 on the rotation framework and to retain or fasten the tine dampeners 135 to the mounting brackets 141. The outer rotation framework 133 may be connected or secured to the inner rotation framework 131 by any one of a number of structures, including framework connectors 139. Further, an outer rotation framework 133 although preferred, is not required to practice the invention, but instead an inner rotation framework 131 with longer tine dampeners 135 may be utilized.

FIG. 3 further illustrates a way in which the tines 134 may be configured and attached to inner rotation framework 131, which is by one or more (two) fasteners 147 which secure the inward ends of the tines 134 to the rotation framework. An example of tines 134 which may be utilized in the embodiment of this invention shown in FIG. 3 is shown in FIG. 8. There are any one of a number of other and different ways the tines may be attached or secured to the rotation framework, with no one in particular being required to practice this invention.

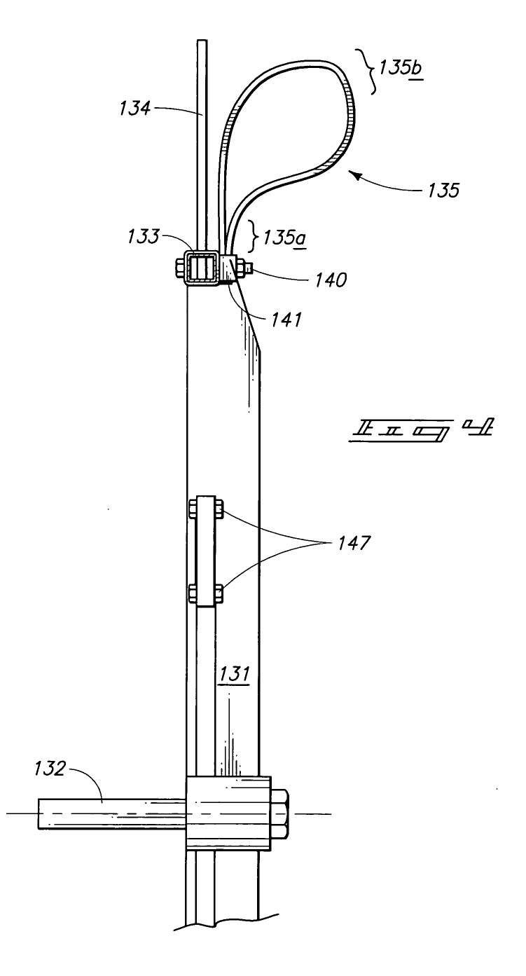

FIG. 4 is an end view of an exemplary tine and a loop from the rake wheel illustrated in FIG. 2. FIG. 4 illustrates inner rotation framework 131, outer rotation framework 133, axis 132, tine 134, tine dampener 135 with radially inward end 135a and radially outward end 135b. The mounting bracket 141 with corresponding fastener 140 fastens the tine dampener 135 to the rotation framework 131 & 133. Tine fastener 147 attaches tine 134 to the rotation framework 131. FIG. 4 further illustrates that the outer rotation framework 133 is or may be a hollow tube, with no particular type of framework being required to practice the invention.

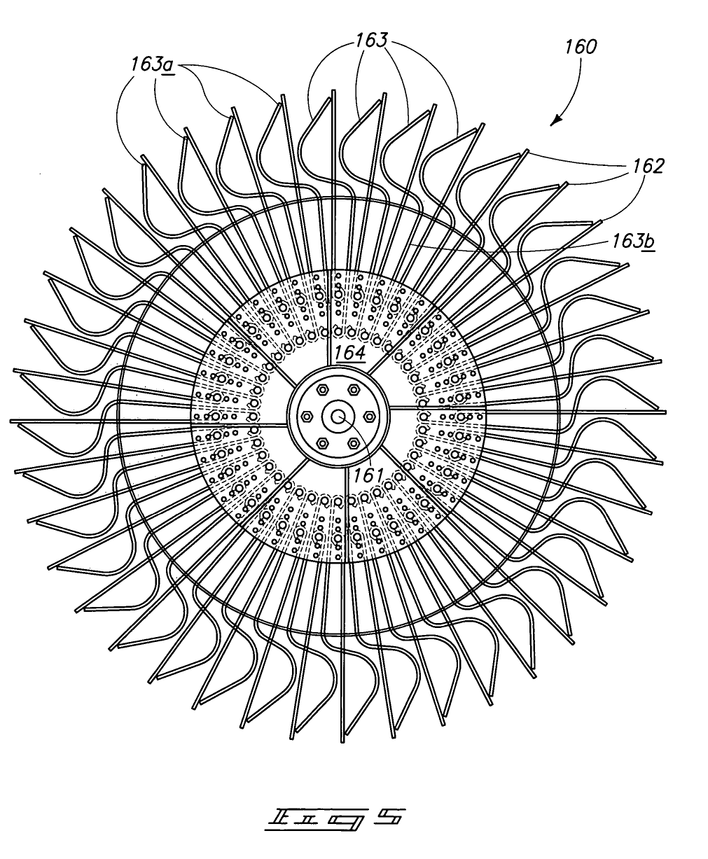

FIG. 5 is a front elevation view of another embodiment of a rake wheel which may be utilized by this invention, wherein the rake is a wheel rake 160, with rake framework 164, and utilizing straight tines 162 with tine dampeners 163. The tine dampeners 163 include radially outward ends 163a and radially inward ends 163b, and in this embodiment is comprised of a semi-flexible or resilient material which has spring characteristics such that when the radially outward ends of the tines 162 penetrate into the ground for instance, the tine dampeners 163 limit or control the depth the tines 162 will penetrate. The force of the tine dampeners 163 will be sufficient to cause the bias suspended framework 164 (as described above) to move upwardly to avoid or reduce the undesired penetration of the tine 162 into the ground.

Another feature of this invention is the ease and stability with which the invention may be moved or transported from location to location. The invention is a pull type crop rake system and it is desirable for the entire system to contract to a width of not greater than eight feet or eight feet six inches, for pulling on roadways in countries such as the United States. It will be appreciated by those of ordinary skill in the art however that it will be preferred for purposes of transporting the invention over the roadways, to have the system contract to a width within the legal limits or restrictions of the countries within which it will be used. In the embodiment for the U.S., the central base framework may be approximately six (6) feet in total width to allow the other desired dimensions to be met.

It is also desirable for the rake system to expand to a larger span to enable a greater width to be raked in one pass of the rake system invention through a crop in the field. These two positions will be referred to as the rake position or the expanded position, and the transport position or contracted position. The length of the extension arms may be varied to accommodate more or fewer rakes, an example of which is a ten rake configuration may effectively rake approximately eighteen feet of hay or crop, and the system may, but is not limited to, raking up to twenty-eight feet of crop at a pass.

It is believed that the avoidance of telescoping features in embodiments of this system will lead to fewer failures and a more reliable system since the pivoting is believed to be a more reliable system in a farm or agriculture environment.

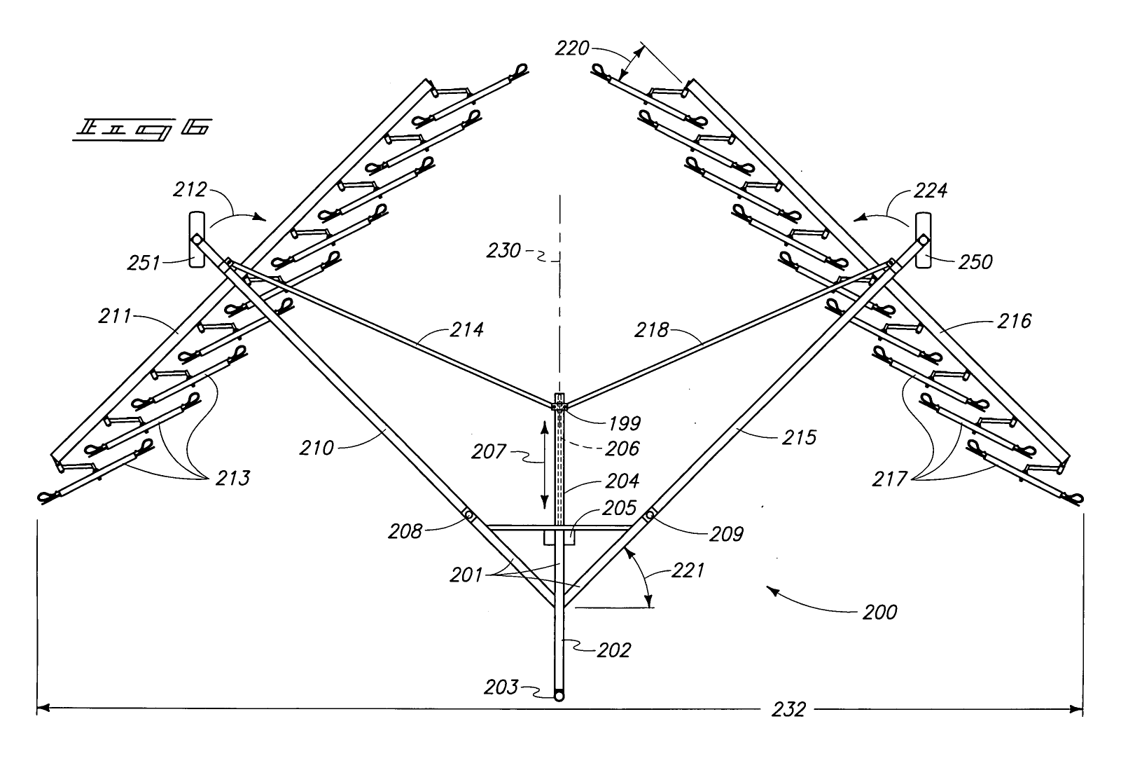

FIG. 6 is a top view of an embodiment of the crop rake system 200 with the framework in a rake or extended position or mode. FIG. 6 illustrates rake width 232, central base framework 201 which includes a central structure and two wing type structures angling out at angle 221 (which may but need not be forty-five degrees), as well as a tongue 202. The tongue 202 is the portion which is between the central base framework and the pulling vehicle and would include a vehicle coupler 203. The vehicle coupler may be any one of a number of couplers, including a hitch for mounting on a ball, a fifth-wheel trailer coupler, a tractor coupler, or any others (with no one application being required to practice the invention).

FIG. 6 further illustrates an embodiment wherein the first extension arm 210 is pivotally connected to central base framework 201 via pivot axis 208 and second extension arm 215 is pivotally connected to central base framework 201 via pivot axis 209. First rake mount arm 211 is pivotally attached to first extension arm 210 and a first plurality of crop rakes 213 are mounted to first rake mount arm 211. Wheels 250 and 251 support first extension arms 210 and 215.

Second rake mount arm 216 is pivotally attached to second extension arm 215 and a second plurality of crop rakes 217 are mounted to second rake mount arm 216. First movement arm 214 is pivotally attached to collar 199 and also pivotally attached to first extension arm 210. Second movement arm 218 is pivotally attached to collar 199 and also pivotally attached to second extension arm 215, as shown. Collar 199 is movably mounted to structure 204 of central base framework 201 such that a hydraulic system 205 with a movable ram 206 causes collar 199 and consequently first movement arm 214 and second movement arm 218 to move therewith.

It will be appreciated by those of ordinary skill in the art that hydraulic and other mechanisms and means to move the components as recited herein are well known in the industry and well within the level of skill of those in the art, and will not be discussed in any further detail herein.

The movement of collar 199 toward the pulling vehicle thereby causes the first extension arm 210 and the second extension arm 215 to contract or move inwardly (as shown by arrows 212 & 224) toward the centerline 230 of the rake system to the approximate extent or position shown in FIG. 7, which may be referred to herein as the transport position (mode) or the contracted position, as it is a position in which the rake system may be pulled over roadways.

While no particular angle of extension arms is required to practice this invention, placing the arms at an angle other than at an approximate right angle to the direction of travel tends to reduce the chances that a failure or breakage will occur in the course of use of the system in the field.

FIG. 7 is a top view of an embodiment of the crop rake system 200 with the framework in a transport or contracted position or mode. FIG. 7 shows a central base framework 201 which includes a central structure and two wing type structures angling out, as well as a tongue 202.

FIG. 7 illustrates the contracted width 231 (for the transport position or mode), central base framework 201 which includes a central structure and two wing type structures angling out at angles 236 and 237, as well as a tongue 202. The tongue 202 is the portion which is between the central base framework and the pulling vehicle and would include a vehicle coupler 203.

FIG. 7 further illustrates an embodiment wherein the first extension arm 210 is pivotally connected to central base framework 201 via pivot axis 208 and second extension arm 215 is pivotally attached to central base framework 201 via pivot axis 209. First rake mount arm 211 is pivotally attached to first extension arm 210 (as shown in later figures) and a first plurality of crop rakes 213 are mounted to first rake mount arm 211.

Second rake mount arm 216 is pivotally attached to second extension arm 215 (as shown in later figures) and a second plurality of crop rakes 217 are mounted to second rake mount arm 216. First movement arm 214 is pivotally attached to collar 199 and also pivotally attached to first extension arm 210. Second movement arm 218 is pivotally attached to collar 199 and also pivotally attached to second extension arm 215, as shown. Collar 199 is movably mounted to structure 204 of central base framework 201 such that a hydraulic system (not shown in FIG. 7, but instead is only shown and described in FIG. 6, may cause collar 199 to move and thereby expand or contract the rake system.

The movement of collar 199 toward the pulling vehicle thereby causes the first extension arm 210 and the second extension arm 215 to contract or move inwardly (as shown by arrows 236 & 237) toward the centerline 230 of the system to the approximate extent or position shown in FIG. 7, the transport position (mode) or the contracted position, in direction of travel 198. Angles 236 and 237 are the angles of the central base framework 201 components and as shown in FIG. 6 the same angles of the first and second extension arms from a direction approximately parallel to the centerline 230 or the direction of travel. Angles 236 and 237 are preferably forty five degrees, although no particular angle is required to practice this invention.

FIG. 8 is a detail front elevation view of an embodiment of an example of a rake tine 134 which may be utilized as part of this invention. Although any one of a number of different types of rake tines may be utilized within the contemplation of this invention, the rake tine 134 shown is a preferred way for the embodiment of the invention shown in FIG. 2.

The rake tine 134 actually includes a first tine 134a and a second tine 135b which are one piece and bent as shown. The tine 134 can easily be attached to the rotation framework utilizing any one of a number of different types of fastening devices and techniques, including screws. If fasteners are utilized, the tines 134 can be secured to the rotation framework such that as the ends of the tines wear the fasteners can be loosened and the tines moved radially outward to compensate for the wear and still maintain the end of the tine in a desired position relative to the tine dampeners (all shown and discussed in other drawings).

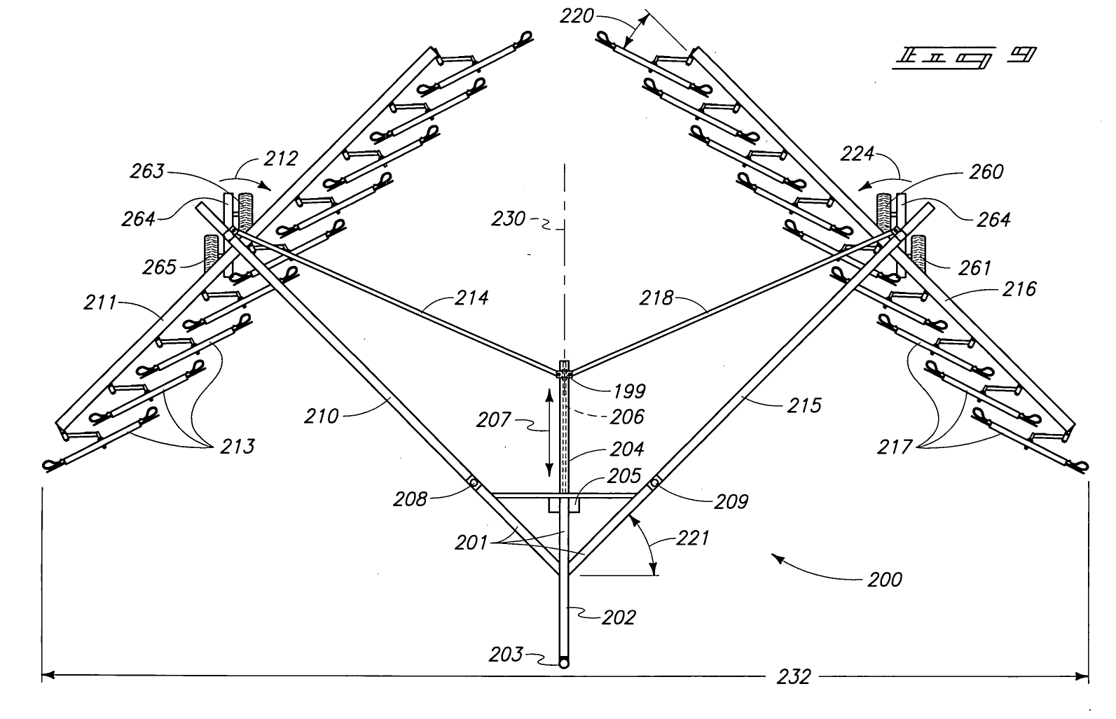

FIG. 9 is a top view of an embodiment of the crop rake system wherein the rake framework is in a rake or extended position or mode and further wherein the wheels are utilized to extend and contract the rake framework. The components and items shown in FIG. 9 are largely the same as shown in FIG. 6, with like numbers attributed to like components, and the identification of each will not therefore be restated here.

While the embodiment in FIG. 6 illustrates a rake framework which may be expanded and contracted based on a central hydraulic system (which are known in the art), as described above, FIG. 9 illustrates a different embodiment wherein the rake framework is expanded and contracted utilizing the pivoting or rotation of the wheels relative to the framework, to power or drive the expansion and contraction.

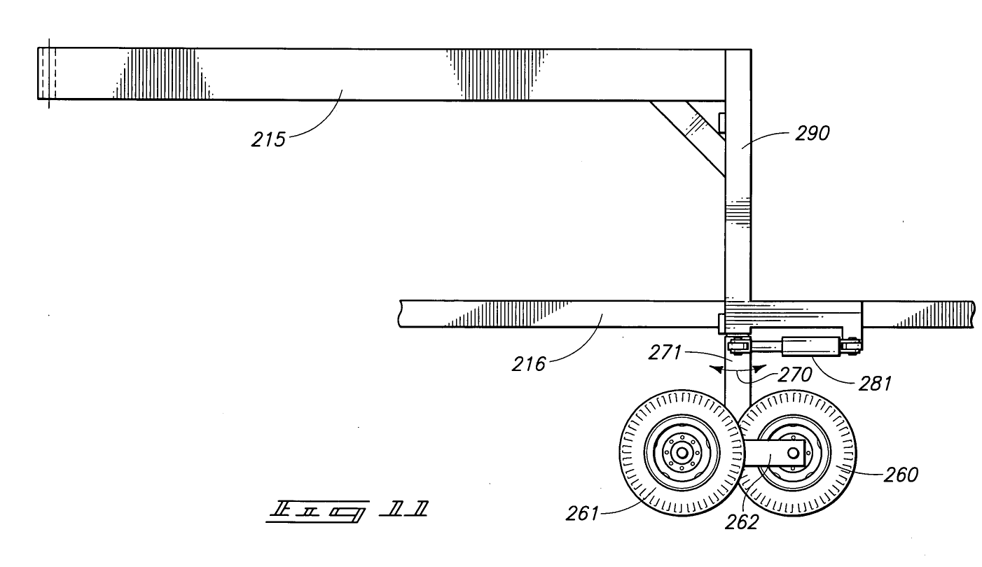

FIG. 9 shows a first wheel configuration supporting and directing first extension arm 210, including first wheel 263 (wheel and tire), second wheel 265, each rotatably mounted to a wheel mount 264. The wheel mount 264 supports both wheels 263 and 265 and is rotatably mounted as support for the first extension arm 210 (as shown in FIG. 11).

FIG. 9 also shows a second wheel configuration similar to the first wheel configuration, only supporting and directing second extension arm 215, including first wheel 260 (wheel and tire), second wheel 261, each rotatably mounted to a wheel mount 264. The wheel mount 264 supports both wheels 260 and 261 and is rotatably mounted as support for the first extension arm 215 (as shown in FIG. 11).

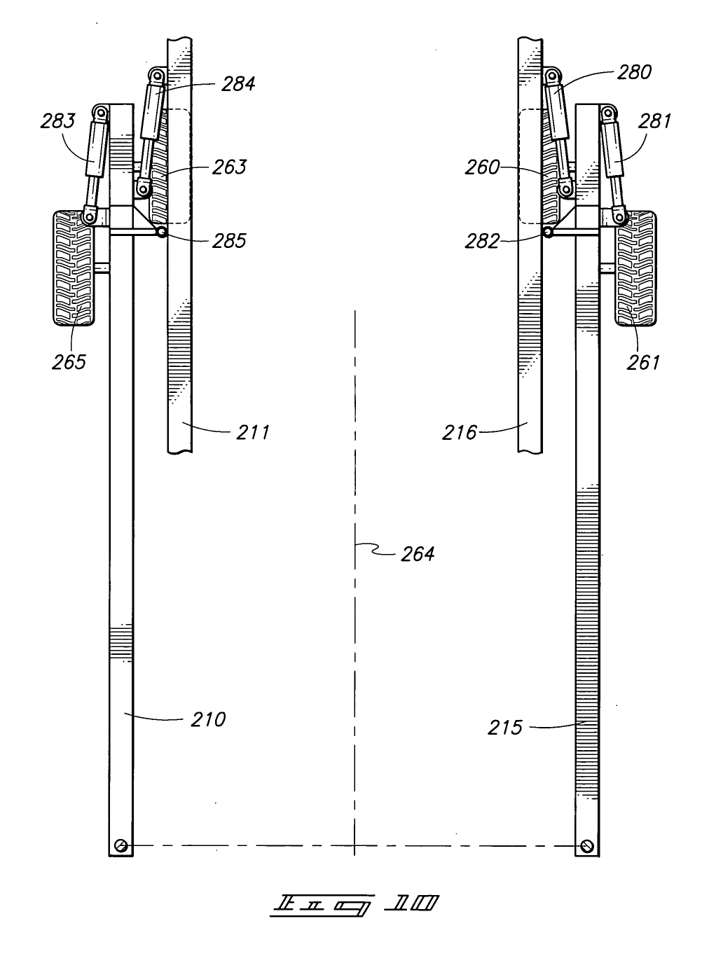

FIG. 10 is top view of an embodiment of the invention illustrating a possible hydraulic configuration for the movement of the wheels and the rake mount arms to accomplish the extension and contraction. Relative to the first wheel configuration on the left side of the figure, FIG. 10 shows first wheel 263, second wheel 265, first wheel hydraulic ram 283 and rake mount structure hydraulic ram 284. The extension and contraction of the first wheel hydraulic ram 283 causes the first wheel configuration to pivot or rotate the direction of the wheels and thereby drive the extension or contraction of the first extension arm 210. The extension and contraction of rake mount structure hydraulic ram 284 causes the movement (pivotal movement in this embodiment) of the rake mount structure 211 relative to the first extension arm 210, thereby providing for movement from the position shown in FIG. 10, to the extended position shown in FIG. 9 for example, for the desired raking width. In order to achieve the desired movement of the rake mount structure 211 relative to the first extension arm 210 (or a support thereof), the rake mount structure 211 may be pivotally mounted to the first extension arm 210 at point 285. Centerline 264 of the rake framework is also illustrated in FIG. 10.

The same configuration is shown for the second wheel configuration on the right side of the figure for this embodiment of the invention, showing first wheel 260, second wheel 261, first wheel hydraulic ram 281 and rake mount structure hydraulic ram 280. The extension and contraction of the first wheel hydraulic ram 281 causes the first wheel configuration to pivot or rotate the direction of the wheels and thereby drive the extension or contraction of the first extension arm 215. The extension and contraction of rake mount structure hydraulic ram 280 causes the movement (pivotal movement in this embodiment) of the rake mount structure 216 relative to the second extension arm 215, thereby providing for movement from the position shown in FIG. 10, to the extended position shown in FIG. 9 for example, for the desired raking width. In order to achieve the desired movement of the rake mount structure 216 relative to the second extension arm 215, the rake mount structure 216 may be pivotally mounted to the first extension arm 215 (or a support thereof) at point 282.

It will be appreciated by those of ordinary skill in the art that there are numerous known ways to accomplish the mechanisms of attachment, pivoting, and hydraulics, which will not therefore be stated in further detail here.

FIG. 11 is a side elevation view of the embodiment of the invention illustrated in FIG. 10, showing the wheel configuration on the right side of FIG. 10. FIG. 11 shows second extension arm 215, rake mount structure 216, support 290 for second extension arm 215 (which in some embodiments may be considered a part of second extension arm 215). First wheel 260, second wheel 261, wheel mount 262 and wheel rotation ram 281. The wheel mount 262 is rotatably mounted to support 290, which may be by any one of a number of different known means, with no one in particular being required to practice this embodiment of this invention. Arrow 270 illustrates the rotation of an upper wheel mount structure 271.

As will be appreciated by those of reasonable skill in the art, there are numerous embodiments to this invention, and variations of elements and components which may be used, all within the scope of this invention.

One embodiment of this invention, for example, is a crop rake system for controlling the depth at which tines on a wheel rake may penetrate a ground surface while raking a crop, comprising: a rotatable rotation framework with an axis of rotation; a plurality of tines mounted to the rotation framework radially outward from the axis of rotation of the rotation framework; and a plurality of tine dampeners mounted to the rotation framework radially outward from the axis of rotation of the rotation framework, the plurality tine dampeners being mounted relative to the plurality of tines such as to determine the depth at which the plurality of tines may penetrate into a ground surface.

Other and additional embodiments from the one described in the preceding paragraph may be a crop rake system as recited above and further: wherein the rotatable rotation framework is a wheel shaped rotation framework; wherein the plurality of tines are adjustably mounted to the rotation framework such that the tines can be moved radially away from the axis of rotation of the rotation framework; wherein the plurality of tine dampeners are flexible loops mounted to the rotation framework adjacent the plurality of tines; wherein the rotation framework is movably mounted to a rake system framework; and/or wherein the rotation framework is bias suspended from a rake system framework.

In another embodiment more particular to wheel configured rakes, the invention contemplates a crop wheel rake system for controlling the depth at which tines on a wheel rake may penetrate a ground surface while raking a crop, the rake system comprising: a wheel framework configured to be rotatably mounted about an axis of rotation; a plurality of tines mounted to the rotation framework radially outward from the axis of rotation of the rotation framework; and at least one tine dampener mounted to the wheel framework radially outward from the axis of rotation, the at least one tine dampeners being mounted relative to the plurality of tines such as to control the depth at which the plurality of tines may penetrate into a ground surface.

Other and additional embodiments from the one described in the preceding paragraph may be a crop rake system as recited above and further: wherein the at least one tine dampener is a dampening tube mounted in a position adjacent the plurality of tines; wherein the damping tube is an inner tube; wherein the damping tube is a tire; wherein the at least one tine dampener is a plurality of semi-flexible loops mounted radially outward to the wheel framework and adjacent the plurality of tines; wherein the plurality of semi-flexible loops mounted radially outward to the wheel framework are comprised of ultra-high molecular weight (UHMW) polyethylene plastic; wherein the plurality of tines are adjustably mounted to the rotation framework such that the tines can be adjustably attached radially away from the axis of rotation of the rotation framework; wherein the rotation framework is movably mounted to a rake system framework; and/or wherein the rotation framework is bias suspended from a rake system framework.

In another embodiment of the invention related to the rake system having a rake position and a transport position, an embodiment may include a pull type crop rake system comprising: a rake system framework comprised of: a central base framework with a pull vehicle coupling; a first extension arm pivotally mounted to a first side of the central base framework, with a first wheel set mounted to and supporting the first extension arm; a second extension arm pivotally mounted to a second side of the central base framework, with a second wheel set mounted to and supporting the second extension arm; a first rake mount structure pivotally mounted to the first extension arm; a second rake mount structure pivotally mounted to the second extension arm; a first plurality of crop rakes pivotally mounted to the first rake mount structure; a second plurality of crop rakes pivotally mounted to the second rake mount structure; wherein the rake system framework has a rake position wherein: the first extension arm and the second extension arm are in an outward position the first rake mount structure is mounted to the first extension arm, is retained in a desired raking position and the second rake mount structure is mounted to the second extension arm, is retained in a desired raking position; and further wherein the rake system framework has a transport position wherein: the first extension arm and the second extension arm are retracted to a position approximately parallel to a direction of travel of the rake system; and the first rake mount structure and the second rake mount structure are retained between the first extension arm and the second extension arm.

Other and additional embodiments from the one described in the preceding paragraph may be a pull type crop rake system as recited above and further: wherein the first plurality of crop rakes is comprised of: a rotatable rotation framework with an axis of rotation; a plurality of tines mounted to the rotation framework radially outward from the axis of rotation of the rotation framework; and a plurality of tine dampeners mounted to the rotation framework radially outward from the axis of rotation of the rotation framework, the plurality tine dampeners being mounted relative to the plurality of tines such as to determine the depth at which the plurality of tines may penetrate into a ground surface.

Other and additional embodiments from the one described in the second preceding paragraph may be a crop rake system as recited above and further: wherein the rotatable rotation framework is a wheel shaped rotation framework; wherein the plurality of tines are adjustably mounted to the rotation framework such that the tines can be moved radially away from the axis of rotation of the rotation framework; wherein the plurality of tine dampeners are flexible loops mounted to the rotation framework adjacent the plurality of tines; wherein the rotation framework is movably mounted to a rake system framework; wherein the rotation framework is bias suspended from a rake system framework; and/or wherein the rake wheel system in the transport position has an overall width of approximately eight and one-half feet or less.

Another embodiment of the invention recited in the third preceding paragraph may be such a rake system framework which further comprises: a first movement arm pivotally mounted to the central base framework and to the first extension arm, and further movably mounted to the central base framework such that the movement of the first movement arm relative to the central base framework moves the first extension arm relative to a centerline to a direction of travel; and a second movement arm pivotally mounted to the central base framework and to the second extension arm, and further movably mounted to the central base framework such that the movement of the second movement arm relative to the central base framework moves the second extension arm relative to the centerline to the direction of travel. In another aspect of this embodiment, it may further be comprised wherein the first movement arm and the second movement arm are moved relative to the central base framework by a hydraulic cylinder.

In yet another embodiment of the invention, a crop wheel rake system may be provided for controlling the depth at which tines on a wheel rake may penetrate a ground surface while raking a crop, the rake system comprising: a wheel framework configured to be rotatably mounted about an axis of rotation; at least one tine means mounted to the rotation framework radially outward from the axis of rotation of the rotation framework; and at least one tine dampener means mounted to the wheel framework radially outward from the axis of rotation, the at least one tine dampener means being mounted relative to the plurality of tine means such as to control the depth at which the at least one tine means may penetrate into a ground surface.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A crop rake system for controlling the depth at which tines on a wheel rake may penetrate a ground surface while raking a crop, comprising:
a rotatable rotation framework with an axis of rotation;
a plurality of tines mounted to the rotation framework radially outward from the axis of rotation of the rotation framework; and
a plurality of tine dampeners mounted to the rotation framework radially outward from the axis of rotation of the rotation framework, the plurality tine dampeners being mounted relative to the plurality of tines such as to determine the depth at which the plurality of tines may penetrate into a ground surface.

2. The crop rake system as recited in claim 1, and further wherein the rotatable rotation framework is a wheel shaped rotation framework.

3. The crop rake system as recited in claim 1, and further wherein the plurality of tines are adjustably mounted to the rotation framework such that the tines can be moved radially away from the axis of rotation of the rotation framework.

4. The crop rake system as recited in claim 1, and further wherein the plurality of tine dampeners are flexible loops mounted to the rotation framework adjacent the plurality of tines.

5. The crop rake system as recited in claim 1, and further wherein the rotation framework is movably mounted to a rake system framework.

6. The crop rake system as recited in claim 1, and further wherein the rotation framework is bias suspended from a rake system framework.

7. A crop wheel rake system for controlling the depth at which tines on a wheel rake may penetrate a ground surface while raking a crop, the rake system comprising:
a wheel framework configured to be rotatably mounted about an axis of rotation;
a plurality of tines mounted to the rotation framework radially outward from the axis of rotation of the rotation framework; and
at least one tine dampener mounted to the wheel framework radially outward from the axis of rotation, the at least one tine dampener being mounted relative to the plurality of tines such as to control the depth at which the plurality of tines may penetrate into a ground surface.

8. The crop rake system as recited in claim 7, and further wherein the at least one tine dampener is a dampening tube mounted in a position adjacent the plurality of tines.

9. The crop rake system as recited in claim 7, and further wherein the damping tube is an inner tube.

10. The crop rake system as recited in claim 7, and further wherein the damping tube is a tire.

11. The crop rake system as recited in claim 7, and further wherein the at least one tine dampener is a plurality of semi-flexible loops mounted radially outward to the wheel framework and adjacent the plurality of tines.

12. The crop rake system as recited in claim 11, and further wherein the plurality of semi-flexible loops mounted radially outward to the wheel framework are comprised of ultra-high molecular weight (UHMW) polyethylene plastic.

13. The crop rake system as recited in claim 7, and further wherein the plurality of tines are adjustably mounted to the rotation framework such that the tines can be adjustably attached radially away from the axis of rotation of the rotation framework.

14. The crop rake system as recited in claim 7, and further wherein the rotation framework is movably mounted to a rake system framework.

15. The crop rake system as recited in claim 7, and further wherein the rotation framework is bias suspended from a rake system framework.

16. A pull type crop rake system comprising:
a rake system framework comprises of:
a central base framework with a pull vehicle coupling;
a first extension arm pivotally mounted to a first side of the central base framework, with a first wheel set mounted to and supporting the first extension arm;
a second extension arm pivotally mounted to a second side of the central base framework, with a second wheel set mounted to and supporting the second extension arm;
a first rake mount structure pivotally mounted to the first extension arm;
a second rake mount structure pivotally mounted to the second extension arm;
a first plurality of crop rakes pivotally mounted to the first rake mount structure;
a second plurality of crop rakes pivotally mounted to the second rake mount structure; and
wherein the rake system framework has a rake position wherein:
the first extension arm and the second extension arm are in an outward position;
the first rake mount structure is mounted relative to the first extension arm in a desired raking position, and the second rake mount structure is mounted relative to the second extension arm in a desired raking position;
and further wherein the rake system framework has a transport position wherein:
the first extension arm and the second extension arm are retracted to a position approximately parallel to a direction of travel of the rake system; and
the first rake mount structure and the second rake mount structure are retained between the first extension arm and the second extension arm.

17. A pull type crop rake system as recited in claim 16, and further wherein the first plurality of crop rakes is comprised of:
a rotatable rotation framework with an axis of rotation;
a plurality of tines mounted to the rotation framework radially outward from the axis of rotation of the rotation framework; and
a plurality of tine dampeners mounted to the rotation framework radially outward from the axis of rotation of the rotation framework, the plurality tine dampeners being mounted relative to the plurality of tines such as to determine the depth at which the plurality of tines may penetrate into a ground surface.

18. A pull type crop rake system as recited in claim 16, and further wherein the rotatable rotation framework is a wheel shaped rotation framework.

19. A pull type crop rake system as recited in claim 16, and further wherein the plurality of tines are adjustably mounted to the rotation framework such that the tines can be moved radially away from the axis of rotation of the rotation framework.

20. A pull type crop rake system as recited in claim 16, and further wherein the plurality of tine dampeners are flexible loops mounted to the rotation framework adjacent the plurality of tines.

21. A pull type crop rake system as recited in claim 16, and further wherein the rotation framework is movably mounted to a rake system framework.

22. A pull type crop rake system as recited in claim 21, and further wherein the rotation framework is bias suspended from a rake system framework.

23. A pull type crop rake system as recited in claim 16, and further wherein the rake wheel system in the transport position has an overall width of approximately eight and one-half feet or less.

24. A pull type crop rake system as recited in claim 17, and further wherein the rake system framework further comprises:
a first movement arm pivotally mounted to the central base framework and to the first extension arm, and further movably mounted to the central base framework such that the movement of the first movement arm relative to the central base framework moves the first extension arm relative to a centerline to a direction of travel; and
a second movement arm pivotally mounted to the central base framework and to the second extension arm, and further movably mounted to the central base framework such that the movement of the second movement arm relative to the central base framework moves the second extension arm relative to the centerline to the direction of travel.

25. A pull type crop rake system as recited in claim 24, and further wherein the first movement arm and the second movement arm are moved relative to the central base framework by a hydraulic cylinder.

26. A crop wheel rake system for controlling the depth at which tines on a wheel rake may penetrate a ground surface while raking a crop, the rake system comprising:
a wheel framework configured to be rotatably mounted about an axis of rotation;
at least one tine means mounted to the rotation framework radially outward from the axis of rotation of the rotation framework; and
at least one tine dampener means mounted to the wheel framework radially outward from the axis of rotation, the at least one tine dampener means being mounted relative to the plurality of tine means such as to control the depth at which the at least one tine means may penetrate into a ground surface.
